(19) United States
(12) Patent Application Publication
(10) Pub. No.: US 2021/0207278 A1
(43) Pub. Date: Jul. 8, 2021

(54) PREPARING FE/NI-FREE ALKALI METAL HYDROXIDE ELECTROLYTES

(71) Applicants: Mohammad Mahdi Najafpour, Zanjan (IR); Mahya Salmanion, Zanjan (IR)

(72) Inventors: Mohammad Mahdi Najafpour, Zanjan (IR); Mahya Salmanion, Zanjan (IR)

(21) Appl. No.: 17/204,959

(22) Filed: Mar. 18, 2021

Related U.S. Application Data
(60) Provisional application No. 63/108,360, filed on Nov. 1, 2020.

(51) Int. Cl. C25C 1/08; C25C 7/02; C25C 7/06

(52) U.S. Cl. CPC C25C 1/08; C25C 7/06; C25C 7/02

(57) ABSTRACT

A method for preparing an Fe/Ni-free alkali metal hydroxide solution may include electrodepositing Ni ions of an alkali metal hydroxide electrolyte on surfaces of an Au anode and an Au cathode by placing the Au anode and the Au cathode within the Fe-free alkali metal hydroxide electrolyte and applying a voltage in a range of 1.75 to 2.25 between the Au anode and the Au cathode for a period in a range of 8 to 12 hours.

### CROSS-REFERENCE TO RELATED APPLICATION

This application claims the benefit of priority from pending U.S. Provisional Patent Application Ser. No. 63/108,360, filed on Nov. 1, 2020, and entitled “A METHOD TO PREPARE FE/NI FREE ALKALI METAL HYDROXIDE SOLUTION,” which is incorporated herein by reference in its entirety.

### TECHNICAL FIELD

The present disclosure relates to systems and methods for purification of alkali metal hydroxide electrolytes. Particularly, the present disclosure relates to systems and methods for removing Fe and Ni impurities from alkali metal hydroxide electrolytes.

### BACKGROUND

Water electrolysis or water splitting may be utilized for storing electrical energy produced from renewable sources, such as sunlight, wind, rain, tides, waves, and geothermal heat. However, such energy storage systems that are developed based on water electrolysis or water splitting may have a considerably low efficiency due to the slow kinetics of oxygen evolution reactions. To overcome such slow kinetics of an oxygen evolution reaction (OER), catalysts such as Ni-based materials are used because Ni-based materials may enhance kinetics of OER. For example, Ni(OH)₂/NiOOH may be one of the most active catalysts for enhancing the kinetics of OER, especially in basic media.

Studies show that catalysts for OER that contain both Ni and Fe have the highest activity among OER catalysts. In other words, the presence of Ni and Fe dramatically enhances the activity of an OER catalyst in a base. In order to understand the role of Fe on the activity, electronic properties, and physical structure of an OER catalyst, there is a need for studying a rigorously Fe-free OER catalyst. However, even trace amounts of Fe in an alkali metal hydroxide electrolyte that may be utilized for water splitting may be incorporated into the OER catalyst. Such incorporation of Fe impurities of the electrolyte into the OER catalyst may affect the evaluation results since such incorporation may not allow for measuring the activity of a rigorously Fe-free OER catalyst.

Consequently, there is a need for a method to remove Fe from an alkali metal hydroxide electrolyte without introducing additional saturated Ni (II) ions into the alkali metal hydroxide electrolyte. Such a method for removing unwanted Fe and Ni impurities from an alkali metal hydroxide electrolyte may allow for understanding the role of Fe in increasing the OER activity without worrying about the presence of unaccounted for Fe or Ni in the water splitting system.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a method for preparing an Fe/Ni-free alkali metal hydroxide solution. An exemplary method may include forming a dispersion by mechanically mixing an Ni(OH)₂ precipitate with an alkali metal hydroxide electrolyte at a stirrer rate in a range of 100 rpm to 300 rpm. An exemplary alkali metal hydroxide electrolyte may include at least one of Lithium hydroxide (LiOH), Sodium hydroxide (NaOH), Potassium hydroxide (KOH), Rubidium hydroxide (RbOH), and Caesium hydroxide (CsOH).

An exemplary method may further include separating the dispersion into a first supernatant and a first pellet by centrifuging the dispersion. An exemplary first supernatant may include an Fe-free alkali metal hydroxide electrolyte.

An exemplary method may further include electrodepositing Ni ions of an exemplary first supernatant on surfaces of an Au anode and an Au cathode by placing an exemplary Au anode and an exemplary Au cathode within an exemplary first supernatant and applying a voltage in a range of 1.75 to 2.25 between an exemplary Au anode and an exemplary Au cathode for a period in a range of 8 to 12 hours. An exemplary method may further include removing an exemplary Au anode and Au cathode from an exemplary first supernatant.

An exemplary method may further include reducing Au ions within an exemplary first supernatant as Au nanoparticles by injecting H₂ gas into an exemplary first supernatant, separating Au nanoparticles from an exemplary first supernatant by centrifuging an exemplary first supernatant to obtain a second supernatant and a second pellet, where an exemplary second pellet may include exemplary Au nanoparticles, and decanting an exemplary second supernatant, where an exemplary second supernatant may include an exemplary Fe/Ni-free alkali metal hydroxide solution.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1A illustrates a flowchart of a method for preparing an Fe/Ni-free alkali metal hydroxide solution, consistent with one or more exemplary embodiments of the present disclosure;

FIG. 1B illustrates a flowchart for performing a step of obtaining an Fe-free alkali metal hydroxide electrolyte, consistent with one or more exemplary embodiment of the present disclosure;

FIG. 1C illustrates a flowchart for performing a step of obtaining an Fe/Ni-free alkali metal hydroxide electrolyte, consistent with one or more exemplary embodiment of the present disclosure;

FIG. 1D illustrates a flowchart for performing a step of separating Au ions from an Fe/Ni-free alkali metal hydroxide electrolyte, consistent with one or more exemplary embodiment of the present disclosure;

FIG. 2 illustrates a schematic of a method for preparing an Fe/Ni-free alkali metal hydroxide solution, consistent with one or more exemplary embodiments of the present disclosure;

FIG. 3A illustrates a scanning electron microscope (SEM) image of the Au anode after performing the electrodeposition, consistent with one or more exemplary embodiments of the present disclosure; and

FIG. 3B illustrates an SEM image of the Au cathode after performing the electrodeposition, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

The present disclosure is directed to exemplary embodiments of a method for preparing an Fe/Ni-free alkali metal hydroxide solution. An exemplary method may be performed in three stages including a first stage of preparing an Fe-free alkali metal hydroxide electrolyte by separating Fe impurity from an alkali metal hydroxide electrolyte. An exemplary first stage may involve separating Fe impurity by utilizing an Ni(OH)₂ precipitate as an Fe absorbent. Such utilization of an exemplary Ni(OH)₂ precipitate may lead to releasing unwanted Ni ions into an exemplary Fe-free alkali metal hydroxide electrolyte. Exemplary unwanted Ni ions within an exemplary Fe-free alkali metal hydroxide electrolyte may be considered as another impurity that may need to be removed from an exemplary alkali metal hydroxide electrolyte.

An exemplary method may include a second stage of removing unwanted Ni ions that may have entered an exemplary Fe-free alkali metal hydroxide electrolyte during Fe absorbance utilizing an exemplary Ni(OH)₂ precipitate. To this end, exemplary Ni ions may be electrodeposited onto surfaces of Au electrodes of an exemplary electrolytic cell with an exemplary Fe-free alkali metal hydroxide solution as an exemplary electrolyte within an exemplary electrolytic tank. Ni ions may be deposited onto exemplary electrodes and may be separated from an exemplary Fe-free alkali metal hydroxide electrolyte to obtain an Fe/Ni-free alkali metal hydroxide electrolyte. Exemplary Ni ions may be removed by removing exemplary electrodes out of an exemplary Fe-free alkali metal hydroxide electrolyte. Due to performing an exemplary electrodeposition process, Au ions may enter an exemplary Fe/Ni-free alkali metal hydroxide electrolyte as impurities.

An exemplary method may include a third stage of removing exemplary Au impurities that may have entered an exemplary Fe/Ni-free alkali metal hydroxide electrolyte due to performing an exemplary electrodeposition process utilizing Au electrodes. An exemplary third stage may involve first reducing exemplary Au ions as Au nanoparticles and then separating exemplary Au nanoparticles by centrifugation or filtering. Each exemplary stage of the aforementioned three stages of an exemplary method for preparing an Fe/Ni-free alkali metal hydroxide solution may be performed in various steps, which are discussed in the following paragraphs.

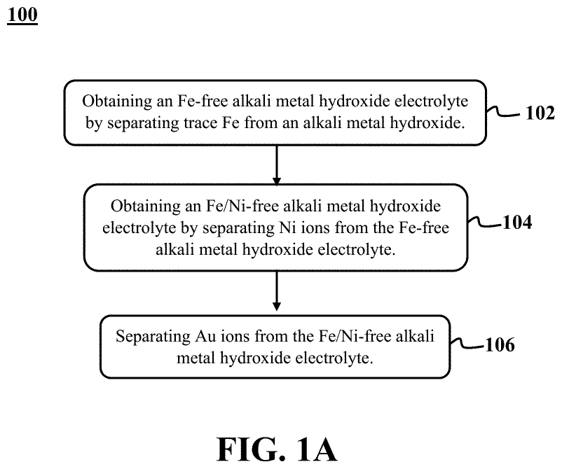

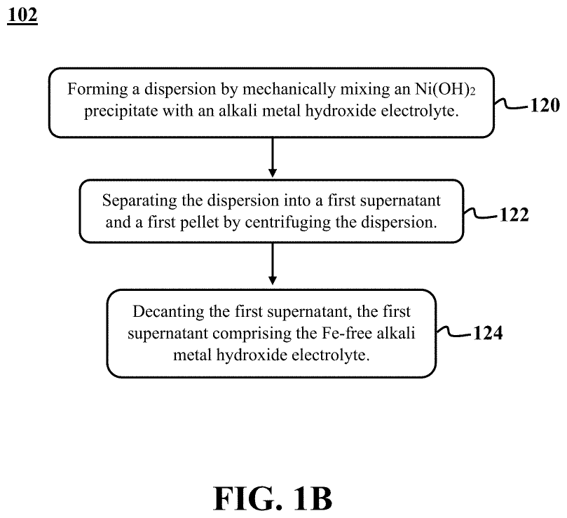

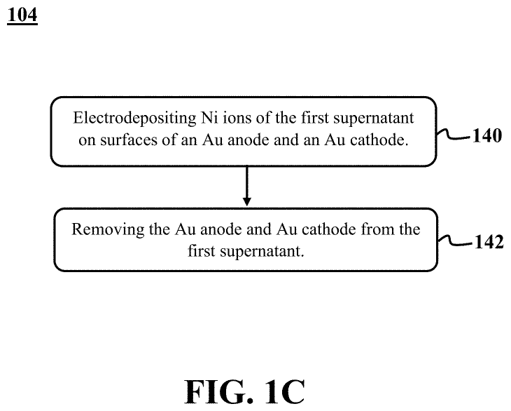

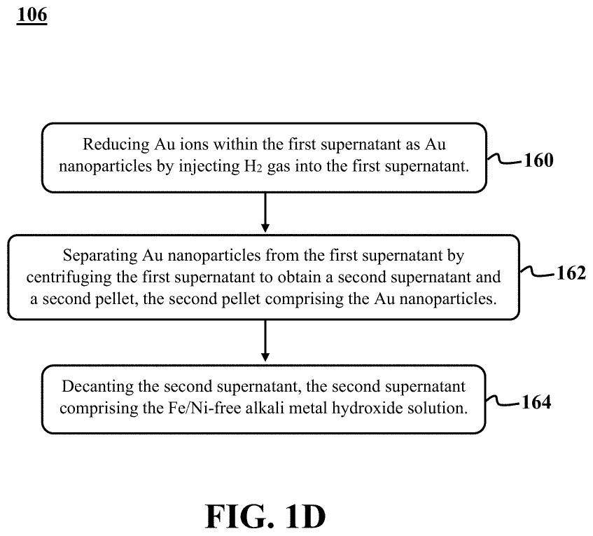

FIG. 1A illustrates a flowchart of a method 100 for preparing an Fe/Ni-free alkali metal hydroxide solution, consistent with one or more exemplary embodiments of the present disclosure. In an exemplary embodiment, method 100 may include a step 102 of obtaining an Fe-free alkali metal hydroxide electrolyte by separating Fe from an alkali metal hydroxide, a step 104 of obtaining an Fe/Ni-free alkali metal hydroxide electrolyte by separating Ni ions from the Fe-free alkali metal hydroxide electrolyte, and a step 106 of separating Au ions from the Fe/Ni-free alkali metal hydroxide electrolyte. As used herein, an Fe-free alkali metal hydroxide electrolyte may refer to an alkali metal hydroxide electrolyte containing less than 0.036 ppm of Fe and an Ni-free alkali metal hydroxide electrolyte may refer to an alkali metal hydroxide electrolyte that may contain less than 1 ppm of Ni ions. As used herein, an Fe/Ni-free alkali metal hydroxide electrolyte may refer to an alkali metal hydroxide electrolyte that may contain less than 0.029 ppm of Fe and less than 0.01 ppm of Ni ions.

FIG. 1B illustrates a flowchart for performing step 102 of obtaining an Fe-free alkali metal hydroxide electrolyte, consistent with one or more exemplary embodiments of the present disclosure. In an exemplary embodiment, step 102 may include a step 120 of forming a dispersion by mixing an Ni(OH)₂ precipitate with an alkali metal hydroxide electrolyte, a step 122 of separating the dispersion into a first supernatant and a first pellet by centrifuging the dispersion, and a step 124 of decanting the first supernatant, where the first supernatant may include the Fe-free alkali metal hydroxide electrolyte.

In an exemplary embodiment, step 120 of forming the dispersion may include mechanically mixing the Ni(OH)₂ precipitate with the alkali metal hydroxide electrolyte at a stirrer rate in a range of 100 rpm to 300 rpm. In an exemplary embodiment, step 120 of forming the dispersion may include mechanically mixing the Ni(OH)₂ precipitate with at least one of Lithium hydroxide (LiOH), Sodium hydroxide (NaOH), Potassium hydroxide (KOH), Rubidium hydroxide (RbOH), and Caesium hydroxide (CsOH). In an exemplary embodiment, Ni(OH)₂ may function as an Fe-absorbent to remove Fe from the alkali metal hydroxide electrolyte. In other words, step 120 may involve exposing the alkali metal hydroxide electrolyte to the Ni(OH)₂ precipitate to allow for absorbance of Fe impurities by the Ni(OH)₂ precipitate.

In an exemplary embodiment, the Ni(OH)₂ precipitate may be obtained by dissolving a specific amount of pure Ni(NO₃)₂.6H₂O in a specific amount of 18.2 MΩ·cm H₂O and then adding a KOH solution to the aqueous solution of Ni(NO₃)₂.6H₂O to precipitate Ni(OH)₂. For example, 2 grams of Ni(NO₃)₂.6H₂O may be dissolved in 4 ml of 18.2 MΩ·cm H₂O and then 20 ml of a 1 M KOH solution may be added to the aqueous solution of Ni(NO₃)₂.6H₂O to precipitate Ni(OH)₂.

In an exemplary embodiment, the obtained Ni(OH)₂ precipitate may be subjected to three wash cycles by redispersing the obtained Ni(OH)₂ precipitate into a mixture of 18.2 MΩ·cm H₂O and KOH. For example, the obtained Ni(OH)₂ precipitate may be redispersed into 20 ml of 18.2 MΩ·cm H₂O and 2 ml of a 1M KOH solution in a centrifuge tube. As used herein, redispersing the Ni(OH)₂ precipitate into a mixture of 18.2 MΩ·cm H₂O and KOH may include either mechanically mixing the Ni(OH)₂ precipitate with the mixture of 18.2 MΩ·cm H₂O and KOH or sonicating a mixture of the Ni(OH)₂ precipitate, 18.2 MΩ·cm H₂O, and KOH in an ultrasound homogenizer. After redispersing the obtained Ni(OH)₂ precipitate, the mixture may further be centrifuged to obtain a pellet and a supernatant. The pellet may include pure Ni(OH)₂ precipitate and the supernatant liquid may be decanted and what remains is the pellet containing the pure Ni(OH)₂ precipitate.

In an exemplary embodiment, step 120 of forming the dispersion may include dispersing the Ni(OH)₂ precipitate into an alkali metal hydroxide electrolyte, mechanically agitating the dispersed Ni(OH)₂ precipitate in the alkali metal hydroxide electrolyte for a few minutes, and then allowing the dispersion to rest for a couple of hours. For example, the dispersed Ni(OH)₂ precipitate in the alkali metal hydroxide electrolyte may be mechanically agitated for at least 10 minutes followed by a 3-hour rest without any mechanical stirring. In an exemplary embodiment, step 120 of forming the dispersion may include dispersing the Ni(OH)₂ precipitate into an alkali metal hydroxide electrolyte, sonicating the dispersed Ni(OH)₂ precipitate in the alkali metal hydroxide electrolyte for a few minutes, and then allowing the dispersion to rest for a couple of hours.

In an exemplary embodiment, step 122 of separating the dispersion into the first supernatant and the first pellet by centrifuging the dispersion may include centrifuging the dispersion at a speed in a range of 3000×g to 15000×g. In an exemplary embodiment, the dispersion may be disposed within a centrifuge tube and then a centrifuge device may be utilized for exerting the centrifugal force to the dispersion to separate solid particles from the dispersion. As used herein, post centrifugation, a precipitate formed at a bottom of the centrifuge tube may be referred to as a pellet and a remaining liquid that may lie above the pellet in the centrifuge tube may be referred to as a supernatant. In an exemplary embodiment, the first supernatant obtained by centrifuging the dispersion may include the Fe-free alkali metal hydroxide electrolyte and may be separated from the first pellet by decantation. As used herein, decantation may refer to pouring the first supernatant off of the centrifuge tube.

In an exemplary embodiment, the first supernatant that may include the Fe-free alkali metal hydroxide electrolyte may be stored in a polypropylene container. To avoid unnecessary contamination of the Fe-free alkali metal hydroxide electrolyte, the polypropylene container may be cleaned by washing the polypropylene container by a 5M H₂SO₄ solution. In an exemplary embodiment, Fe may be removed to a level of less than 0.036 ppm by performing step 102 of method 100, however at the expense of introducing saturated Ni(II) ions into the alkali metal hydroxide electrolyte. As mentioned before, such presence of Ni ions in the electrolyte may affect investigating the effects of Ni and Fe on the activity of OER catalysts. Consequently, such unwanted Ni ions within the first supernatant must be removed to obtain an Fe/Ni-free alkali metal hydroxide electrolyte.

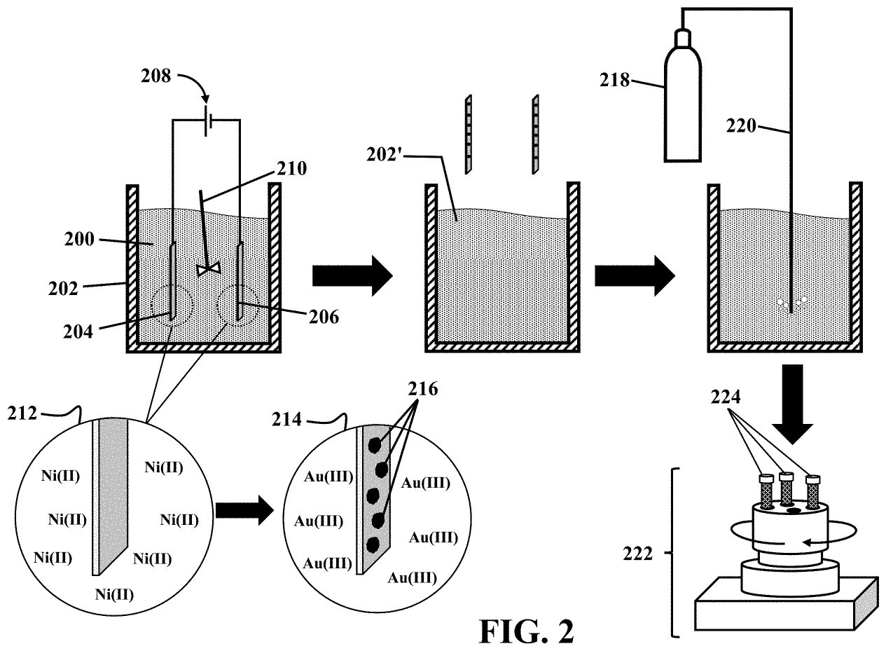

FIG. 1C illustrates a flowchart for performing step 104 of obtaining the Fe/Ni-free alkali metal hydroxide electrolyte, consistent with one or more exemplary embodiments of the present disclosure. FIG. 2 illustrates a schematic of a method for preparing an Fe/Ni-free alkali metal hydroxide solution, consistent with one or more exemplary embodiments of the present disclosure. In an exemplary embodiment, FIG. 2 is a schematic representation of steps 104 and 106 of method 100 for preparing an Fe/Ni-free alkali metal hydroxide solution.

In an exemplary embodiment, step 104 may include a step 140 of electrodepositing Ni ions of the first supernatant on surfaces of an Au anode and an Au cathode and a step 142 of removing the Au anode and Au cathode from the first supernatant. As used herein, Ni ions of the first supernatant may refer to saturated Ni(II) ions that may be introduced into the first supernatant during step 102 of obtaining the Fe-free alkali metal hydroxide electrolyte.

In an exemplary embodiment, step 140 may include electrodepositing Ni ions of the first supernatant on surfaces of the Au anode and the Au cathode by placing the Au anode and the Au cathode within the first supernatant and applying a voltage in a range of 1.75 to 2.25 between the Au anode and the Au cathode for a period in a range of 8 to 12 hours. For example, an Fe-free alkali metal hydroxide electrolyte 200, which is an alkali metal hydroxide electrolyte that has passed through an Fe removal process similar to step 102 of method 100, may be disposed within an agitated electrolytic tank 202. In an exemplary embodiment, Fe-free alkali metal hydroxide electrolyte 200 may interact with an Au cathode 204 and an Au anode 206, which are immersed in Fe-free alkali metal hydroxide electrolyte 200. Such interaction between Fe-free alkali metal hydroxide electrolyte 200 with Au cathode 204 and Au anode 206 may be in response to the applied voltage utilizing a power source 208 between Au cathode 204 and Au anode 206. In an exemplary embodiment, Au anode 206 may be a rectangular Au foil and Au cathode 204 may similarly be a rectangular Au foil. For example, Au anode 206 and Au cathode 204 may be rectangular Au foils with thicknesses of 1 mm. In an exemplary embodiment, electrolytic tank 202 may operate in a range of 20 to 30° C. In an exemplary embodiment, the spacing between Au cathode 204 and Au anode 206 may be adjusted to provide separation of the electro-chemical reactions occurring at Au cathode 204 and at Au anode 206, while avoiding short circuiting within electrolytic tank 202. For example, for an electrolytic tank with a volume of 50, a distance between an anode and cathode electrodes in a range of 3 and 5 cm may be considered suitable.

In an exemplary embodiment, step 140 may further include concurrently mechanically agitating the alkali metal hydroxide electrolyte at a stirrer rate in a range of 200 rpm to 400 rpm. For example, mechanical agitation within electrolytic tank 202 may be provided by utilizing a mechanical agitator 210, which may be actuated by a rotary actuator, such as an electromotor. Such mechanical agitation during voltage application may allow for a faster diffusion of Ni ions towards the surfaces of the Au anode and the Au cathode.

Referring to insets (212 and 214) of FIG. 2, under the influence of the applied voltage between Au cathode 204 and Au anode 206, Ni ions may be deposited onto the Au anode and the Au cathode as black spots on the outer surfaces of the Au anode and the Au cathode. For example, in inset 214, deposited Ni ions are illustrated by black spots 216 on an outer surface of an electrode, which may be either Au anode 206 or Au cathode 204. In an exemplary embodiment, by applying a voltage between Au anode 206 and Au cathode 204, oxidation of Ni (II) occurs according to Reaction (1) below and NiO(OH) may be deposited on an outer surface of Au anode 206. On the other hand, Ni (II) may further be deposited as Ni(OH)₂ on an outer surface of Au cathode 204 based on Reactions (2) and (3) represented below.

Ni(aq)²⁺+3OH⁻→NiO(OH)+H₂O+e⁻ Reaction (1)

2H₂O+2e⁻→H₂+2OH Reaction (2)

2OH⁻+Ni(aq)²⁺→Ni(OH)₂ Reaction (3)

In an exemplary embodiment, the electrodeposited Ni ions on the Au anode and the Au cathode may be removed from the first supernatant by removing the Au anode and Au cathode from the first supernatant to obtain an Fe/Ni-free alkali metal hydroxide electrolyte. For example, Au anode 206 and Au cathode 204 may be removed from now Fe/Ni-free alkali metal hydroxide electrolyte 202′. In an exemplary embodiment, released Au ions may be considered another unwanted impurity that needs to be separated to obtain an Fe/Ni-free alkali metal hydroxide electrolyte without any unwanted impurities.

FIG. 1D illustrates a flowchart for performing step 106 of separating Au ions from the Fe/Ni-free alkali metal hydroxide electrolyte, consistent with one or more exemplary embodiment of the present disclosure. In an exemplary embodiment, step 106 may include a step 160 of reducing Au ions within the first supernatant as Au nanoparticles by injecting H₂ gas into the first supernatant, a step 162 of separating Au nanoparticles from the first supernatant by centrifuging the first supernatant to obtain a second supernatant and a second pellet, where the second pellet may include the Au nanoparticles, and a step 164 of decanting the second supernatant, where the second supernatant includes the Fe/Ni-free alkali metal hydroxide solution. For example, H₂ gas may be injected into obtained Fe/Ni-free alkali metal hydroxide electrolyte 202′ from a pressurized source 218 of H₂ via a gas line 220. In response to H₂ gas being injected into Fe/Ni-free alkali metal hydroxide electrolyte 202′, Au ions may be reduced to nanosized metallic Au. As mentioned before, the reduced Au ions may then be separated by centrifuging the first supernatant in a centrifuge device such as centrifuge device 222. In an exemplary embodiment, centrifuge device 222 may provide a speed in a range of 700×g to 14000×g. Post centrifugation, the second supernatant containing the Fe/Ni-free alkali metal hydroxide solution may be decanted by being poured off of centrifuge tubes 224.

### EXAMPLE

In this example, an Fe/Ni-free KOH electrolyte was prepared by a method similar to method 100 for preparing an Fe/Ni-free alkali metal hydroxide solution. First, an Fe-free KOH electrolyte was prepared by dispersing an Ni(OH)₂ precipitate in 50 ml of a 1M KOH solution.

To this end, an Ni(OH)₂ precipitate was formed by dissolving 2 grams of Ni(NO₃)₂.6H₂O be 4 ml of 18.2 MΩ·cm H₂O and then adding 20 ml of a 1 M KOH solution to the aqueous solution of Ni(NO₃)₂.6H₂O. After forming the Ni(OH)₂ precipitate, a centrifuge tube was filled with 50 ml of a 1M KOH solution, and the Ni(OH)₂ precipitate was redispersed into the 1M KOH solution and was mechanically agitated for at least 10 minutes followed by a 3-hour rest. Then the dispersion was centrifuged at a speed of 6000×g to obtain an Fe-free KOH solution as a supernatant. The obtained supernatant was then decanted by pouring the Fe-free KOH solution off of the centrifuge tube.

After obtaining the Fe-free KOH solution, unwanted Ni ions within the Fe-free KOH solution were separated. To this end, the Fe-free KOH solution was poured into an electrolytic tank such as electrolytic tank 202 and two Au electrodes similar to Au cathode 204 and Au anode 206 were immersed within the Fe-free KOH solution. Then, Ni ions were electrodeposited onto the electrodes by applying a voltage of 2.0 V between the electrodes under mechanical stirring with a rate of 250 rpm. In this example, each of the anode and cathode electrodes were made of rectangular 2 cm×3 cm Au foils with an average thicknesses of 1 mm.

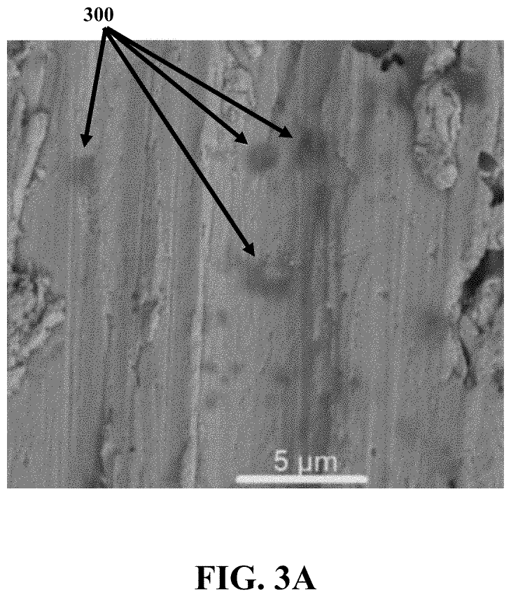

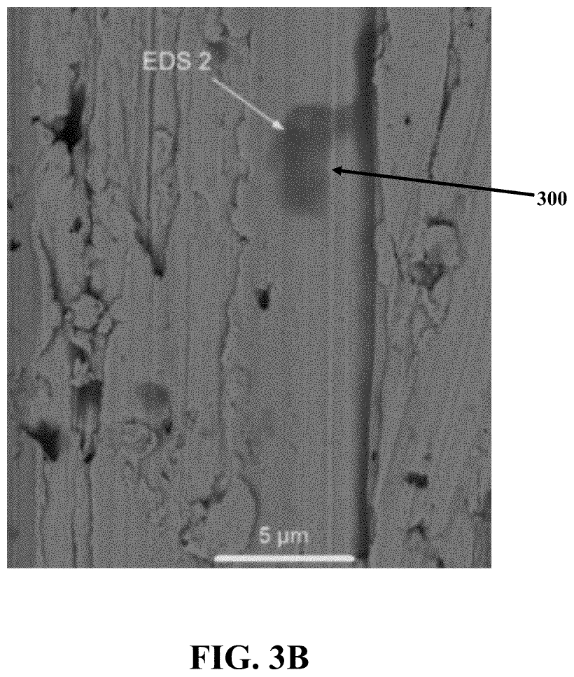

FIG. 3A illustrates a scanning electron microscope (SEM) image of the Au anode after performing the electrodeposition, consistent with one or more exemplary embodiments of the present disclosure. FIG. 3B illustrates an SEM image of the Au cathode after performing the electrodeposition, consistent with one or more exemplary embodiments of the present disclosure. In an exemplary embodiment, the electrodeposition was performed by a method similar to method 100. As evident in FIGS. 3A and 3B, Ni ions were deposited on an outer surface of the anode and cathode electrodes similar to step 140, and the deposited Ni ions are observable as black spots 300.

After Ni ions were electrodeposited on the electrodes in a step similar to step 140, the electrodes were removed from the now Fe/Ni-free KOH solution in a step similar to step 142. Then, in a step similar to step 160 hydrogen gas was injected into the KOH solution to reduce the Au impurities within the KOH solution as Au nanoparticles. Then, Au nanoparticles were separated from the Fe/Ni-free KOH solution by centrifuging the solution in a step similar to step 162 and then decanting the pure Fe/Ni-free KOH solution in a step similar to step 164.

In an exemplary embodiment, conventional methods for separating trace Fe from an alkali metal hydroxide electrolyte such as KOH lead to introduction of Ni ions in the electrolyte, whereas exemplary methods may allow for first separating trace Fe from an alkali metal hydroxide electrolyte and then separating introduced Ni ions by an electrodeposition reaction performed in an electrolytic cell with two Au electrodes. Exemplary methods may further allow for separating Au ions introduced into the electrolyte due to the electrodeposition reaction to obtain an Fe-/Ni-free alkali metal hydroxide electrolyte free from any unwanted impurities.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps. Moreover, the word “substantially” when used with an adjective or adverb is intended to enhance the scope of the particular characteristic, e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A method for preparing an Fe/Ni-free alkali metal hydroxide solution, the method comprising:
forming a dispersion by mechanically mixing an Ni(OH)₂ precipitate with an alkali metal hydroxide electrolyte at a stirrer rate in a range of 100 rpm to 300 rpm, the alkali metal hydroxide electrolyte comprising at least one of Lithium hydroxide (LiOH), Sodium hydroxide (NaOH), Potassium hydroxide (KOH), Rubidium hydroxide (RbOH), and Caesium hydroxide (CsOH);
separating the dispersion into a first supernatant and a first pellet by centrifuging the dispersion, the first supernatant comprising an Fe-free alkali metal hydroxide electrolyte;
electrodepositing Ni ions of the first supernatant on surfaces of an Au anode and an Au cathode by placing the Au anode and the Au cathode within the first supernatant and applying a voltage in a range of 1.75 to 2.25 between the Au anode and the Au cathode for a period in a range of 8 to 12 hours;
removing the Au anode and Au cathode from the first supernatant;
reducing Au ions within the first supernatant as Au nanoparticles by injecting H₂ gas into the first supernatant;
separating Au nanoparticles from the first supernatant by centrifuging the first supernatant to obtain a second supernatant and a second pellet, the second pellet comprising the Au nanoparticles; and
decanting the second supernatant, the second supernatant comprising the Fe/Ni-free alkali metal hydroxide solution.

2. A method for preparing an Fe/Ni-free alkali metal hydroxide solution, the method comprising:
electrodepositing Ni ions of an alkali metal hydroxide electrolyte on surfaces of an Au anode and an Au cathode by placing the Au anode and the Au cathode within the Fe-free alkali metal hydroxide electrolyte and applying a voltage in a range of 1.75 to 2.25 between the Au anode and the Au cathode for a period in a range of 8 to 12 hours.

3. The method of claim 2, wherein electrodepositing Ni ions of the alkali metal hydroxide electrolyte on surfaces of an Au anode and an Au cathode further comprises mechanically agitating the alkali metal hydroxide electrolyte at a stirrer rate in a range of 200 rpm to 400 rpm.

4. The method of claim 2, further comprising removing the electrodeposited Ni ions on the Au anode and the Au cathode from the alkali metal hydroxide electrolyte by removing the Au anode and Au cathode from the alkali metal hydroxide electrolyte.

5. The method of claim 4, further comprising separating Au ions from the alkali metal hydroxide electrolyte by reducing the Au ions within the alkali metal hydroxide electrolyte as Au nanoparticles by injecting H₂ gas into the alkali metal hydroxide electrolyte.

6. The method of claim 5, further comprising separating the Au nanoparticles from the alkali metal hydroxide electrolyte by centrifuging the alkali metal hydroxide electrolyte to obtain a second supernatant and a second pellet, the second pellet comprising the Au nanoparticles.

7. The method of claim 6, wherein separating the Au nanoparticles from the alkali metal hydroxide electrolyte further comprises decanting the second supernatant, the second supernatant comprising an Au-free alkali metal hydroxide electrolyte.

8. A method for preparing an Fe/Ni-free alkali metal hydroxide solution, the method comprising:
forming a dispersion by mixing an Ni(OH)₂ precipitate with an alkali metal hydroxide electrolyte;
separating the dispersion into a first supernatant and a first pellet by centrifuging the dispersion, the first supernatant comprising an Fe-free alkali metal hydroxide electrolyte; and
electrodepositing Ni ions of the first supernatant on surfaces of an Au anode and an Au cathode by placing the Au anode and the Au cathode within the first supernatant and applying a voltage in a range of 1.75 to 2.25 between the Au anode and the Au cathode for a period in a range of 8 to 12 hours.

9. The method of claim 8, wherein mixing the Ni(OH)₂ precipitate with the alkali metal hydroxide electrolyte comprises mechanically mixing the Ni(OH)₂ precipitate with the alkali metal hydroxide electrolyte at a stirrer rate in a range of 100 rpm to 300 rpm.

10. The method of claim 9, wherein mechanically mixing the Ni(OH)₂ precipitate with the alkali metal hydroxide electrolyte comprises mechanically mixing the Ni(OH)₂ precipitate with at least one of Lithium hydroxide (LiOH), Sodium hydroxide (NaOH), Potassium hydroxide (KOH), Rubidium hydroxide (RbOH), and Caesium hydroxide (CsOH).

11. The method of claim 8, wherein electrodepositing Ni ions of the first supernatant on surfaces of an Au anode and an Au cathode further comprises mechanically agitating the first supernatant at a stirrer rate in a range of 200 rpm to 400 rpm.

12. The method of claim 8, further comprising removing the electrodeposited Ni ions on the Au anode and the Au cathode from the first supernatant by removing the Au anode and Au cathode from the first supernatant.

13. The method of claim 12, further comprising separating Au ions from the first supernatant by reducing the Au ions within the first supernatant as Au nanoparticles by injecting H₂ gas into the first supernatant.

14. The method of claim 13, further comprising separating the Au nanoparticles from the first supernatant by centrifuging the first supernatant to obtain a second supernatant and a second pellet, the second pellet comprising the Au nanoparticles.

15. The method of claim 14, wherein separating the Au nanoparticles from the first supernatant further comprises decanting the second supernatant, the second supernatant comprising an Au-free alkali metal hydroxide electrolyte.
